(19) United States
(12) Patent Application Publication
(10) Pub. No.: US 2023/0418935 A1
(43) Pub. Date: Dec. 28, 2023

(54) DETECTING TAMPERING IN DATA PROCESSING PIPELINES

(71) Applicant: VMware, Inc., Palo Alto, CA (US)

(72) Inventors: Shawn Rud Hartsock, Chapel Hill, NC (US); Adrian Oney, Palo Alto, CA (US)

(21) Appl. No.: 17/850,541

(22) Filed: Jun. 27, 2022

(51) Int. Cl. G06F 21/55

(52) U.S. Cl. CPC G06F 21/554; G06F 2221/034

(57) ABSTRACT

Techniques for detecting tampering in a data processing pipeline are provided. At a high level, these techniques involve instrumenting each transformer in the data processing pipeline to (1) compute a digest of the input data it actually receives for processing, and (2) generate an immutable log entry that records, among other things, the computed input digest and a digest of the resulting output data. With this approach, if an adversary attempts to tamper with the input data for a transformer, the tampering will be evident due to an “orphaned link scenario” in which the input digest for the log entry generated by that transformer fails to map to the output digest of any other log entry (or to the digest of input data from a known data source).

### BACKGROUND

Unless otherwise indicated, the subject matter described in this section is not prior art to the claims of the present application and is not admitted as being prior art by inclusion in this section.

Modern software is created via a series of steps, known as a software supply chain, that begins with the software's source code and ends with delivery of the software to end-users. Typically, these steps are chained together such that the output of one step is provided as the input to another downstream step, ultimately leading to the final (i.e., delivered) software product. For example, source code can be retrieved from a source code management (SCM) system and provided as input to a compiler, which can generate a set of binaries; the binaries can then be provided as input to one or more packaging scripts, which can generate an installable package; and the installable package can be provided as input to a deployment process, which can install the package in a production environment.

Securing a software supply chain against attacks is critical to maintaining the integrity of the resulting software. Existing approaches to software supply chain security generally focus on securing the individual steps/components within the supply chain such as the SCM system, compiler, and so on. However, these approaches are susceptible to man-in-the-middle attacks that tamper with data passed between the steps/components. For instance, an adversary may surreptitiously swap the source code that is provided as input to a compiler with malicious source code, thereby introducing a security vulnerability into the final software product.

### BRIEF DESCRIPTION OF THE DRAWINGS

FIG. 1 depicts an example environment comprising a data processing pipeline.

FIGS. 2A, 2B, and 2C depict an example software supply chain and a man-in-the-middle attack scenario with respect to the supply chain.

FIG. 3 depicts an enhanced version of the software supply chain of FIG. 2 according to certain embodiments.

FIG. 4 depicts a transformer processing workflow according to certain embodiments.

FIG. 5 depicts a tampering detection workflow according to certain embodiments.

FIG. 6 depicts a transformer processing workflow that leverages a secure hardware enclave according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to techniques for detecting tampering in a data processing pipeline comprising a series of data transformation steps (referred to herein as “transformers”), such as a software supply chain. An example of this tampering is a man-in-the-middle attack in which an adversary replaces the input to a transformer with their own, malicious input.

At a high level, these techniques involve instrumenting each transformer in the data processing pipeline to (1) compute a digest (e.g., cryptographic hash or multi-hash, content identifier, etc.) of the input data it actually receives for processing, and (2) generate an immutable (i.e., non-modifiable) log entry that records, among other things, the computed input digest and a digest of the resulting output data. With this approach, if an adversary attempts to tamper with the input data for a transformer, the tampering will be evident due to an “orphaned link scenario” in which the input digest for the log entry generated by that transformer fails to map to the output digest of any other log entry (or to the digest of input data from a known data source).

### 2. Example Environment and Problem Definition

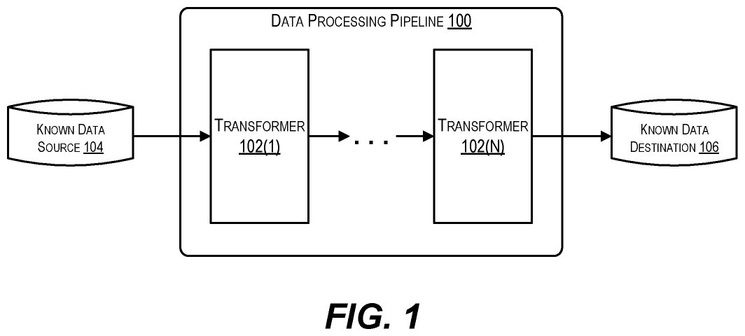

FIG. 1 depicts an example environment comprising a data processing pipeline 100 in which embodiments of the present disclosure may be implemented. As shown, data processing pipeline 100 includes a chained sequence of data transformation steps (i.e., transformers) 102(1)-(N), each of which is configured receive input data from an upstream transformer (or from a known data source 104), operate on the input data in some fashion, and generate output data that is passed as input to a downstream transformer (or to a known data destination 106). Typically, transformers 102(1)-(N) will be implemented via software packaged as containers, virtual machines, etc. that run on one or more physical computer systems.

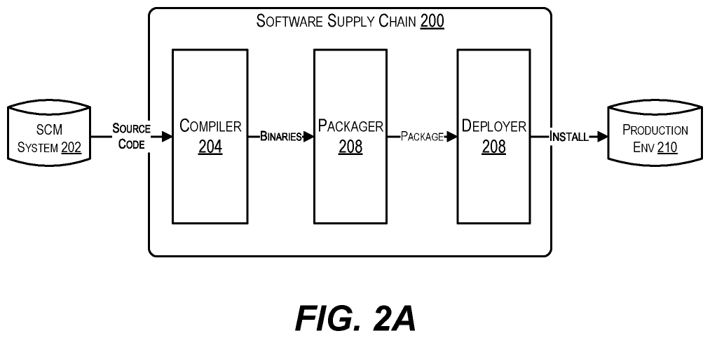

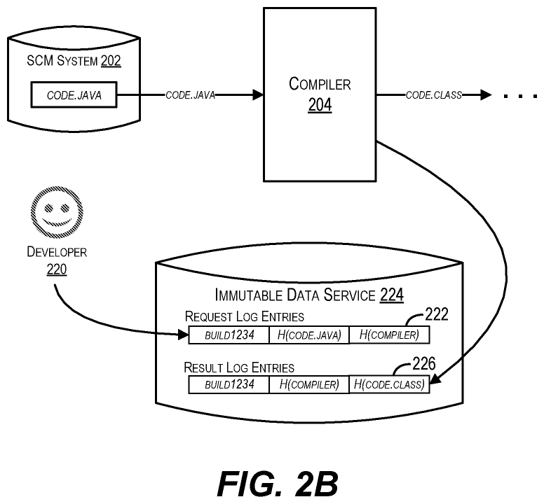

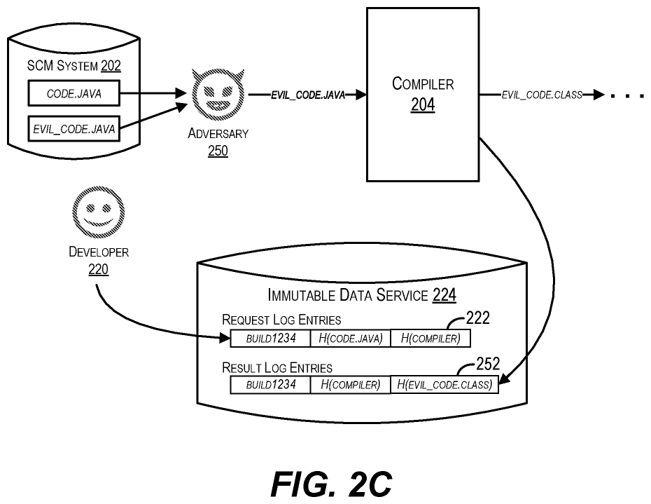

In one set of embodiments, data processing pipeline 100 may be a software supply chain for building and deploying a software product. For instance, FIG. 2A depicts a software supply chain 200 that receives source code from an SCM system 202 (corresponding to known data source 104) and passes the source code as input to a compiler 204 (corresponding to a first transformer 102(1)). Compiler 204 compiles the source code into one or more binaries and passes the binaries as input to a packager 206 (corresponding to a second transformer 102(2)). Packager 206 packages the binaries into an installable package and passes the package as input to a deployer 208 (corresponding to a third transformer 102(3)). Finally, deployer 208 installs the package in a production environment 210 (corresponding to known data destination 106) for use by end-users. Software supply chain 200 is presented as an illustrative example and thus is relatively simple; in real life, software supply chains may include many other types of transformers (e.g., preprocessors, automated testers, localization utilities, etc.) that are interlinked via a complex chain.

In alternative embodiments, data processing pipeline 100 may be any other type of pipeline or system that involves passing data between different steps/components for the purpose of performing data transformation/processing at each step (e.g., business-to-business data exchange pipelines, extract-transform-load (ETL) pipelines for data warehousing, etc.).

As noted in the Background section, securing a data processing pipeline like pipeline 100 of FIG. 1 is critical for maintaining the overall security of the pipeline's output. According to one approach, the machines hosting each individual transformer 102 (as well as known data source 104 and known data destination 106) can be hardened against adversarial attacks, such as through the use of secure-booted, tamper-resistant operating systems and file systems. In addition, the various actors that drive or implement the data processing pipeline can record their actions/outputs via immutable log entries that are linked via job identifiers (IDs), thereby producing tamper-resistant audit trails that track the pipeline's operation.

For example, with respect software supply chain 200 of FIG. 2A, assume a developer wishes to compile her source code code.java held in SCM system 202 using compiler 204. In this scenario (depicted in FIG. 2B), the developer (reference numeral 220) can submit a job request for performing this compilation and can create a request log entry 222 in an immutable data service 224 that includes, among other things, a job ID for this job request (i.e., build1234), a digest (e.g., cryptographic hash) of code.java that uniquely represents its contents (i.e., h(code.java)), and a digest of compiler 204 (i.e., h(compiler)). The digest of compiler 204 may be registered with a registration service (not shown) that indicates compiler 204 is authentic/trusted.

In response to the job request, compiler 204 can retrieve code.java from SCM system 202 and compile it, thereby producing the output binary code.class. Compiler 204 can then write a result log entry 226 in immutable data service 224 that includes the job ID build1234, the compiler digest h(compiler), and a digest of code.class (i.e., h(code.class)). This enables developer 220 to later search the result log entries held in immutable data service 224 using her job ID build1234 and, upon finding matching result log entry 226, can conclude that the job request was successfully processed (resulting in the binary code.class).

However, an issue with the foregoing is that, as shown in FIG. 2C, an adversary 250 may perpetrate a man-in-the-middle attack that swaps the code.java file provided as input to compiler 204 with another, malicious version (e.g., evil_code.java), thereby causing compiler 204 to act upon this malicious version and generate the binary evil_code.class. For example, adversary 250 may secretly remap the file path of code.java in SCM system 202 to a completely different directory or different data source location.

In this case, compiler 204 will still generate a result log entry in immutable data service 224 at the end of its processing and this result log entry (shown via reference numeral 252) will now identify a digest of evil_code.class (i.e., h(evil_code.class)) rather than the digest of code.class. However, because result log entry 252 does not record the actual input data that compiler 204 acted upon (i.e., evil_code.java), it is not possible to detect the tampering performed by adversary 250. Instead, developer 220 will find this result log entry by searching on her job ID build1234 and assume that evil_code.class is the compiler output for her original code.java, which is incorrect.

### 3. Solution Description

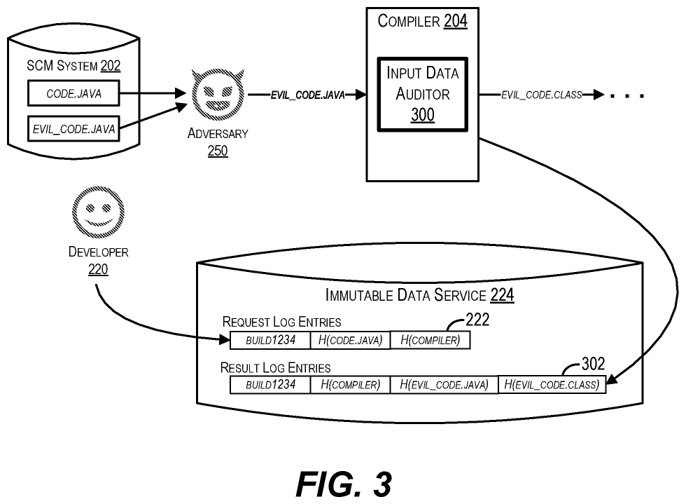

To address the foregoing and other similar scenarios, FIG. 3 depicts an enhanced version of software supply chain 200 that includes, in compiler 204 and every other transformer of the supply chain, a novel “input data auditor” component 300 according to various embodiments. Generally speaking, input data auditor 300 comprises logic that enables compiler 204 to (1) compute a digest of the input data that it actually receives/sees at runtime and (2) write a result log entry to immutable data service 224 that includes the computed input digest, in addition to other relevant information (e.g., job ID, output digest, etc.). This input digest may be a cryptographic hash, multi-hash, content identifier, or any other value that uniquely (or almost uniquely) identifies the content of the input data, such that if any portion of the input data changes, its digest will also change.

For example, as shown in FIG. 3, if compiler 204 receives evil_code.java as input due to the man-in-the-middle attack perpetrated by adversary 250, compiler 204 can compute a digest of evil_code.java (i.e., h(evil_code.java)) via input data auditor 300 and can write a result log entry 302 to immutable data service 224 that includes this computed input digest (as well as the job ID build1234, the compiler digest h(compiler), and the output digest h(evil_code.class)). The same input digest computation and logging can be performed by every other transformer in software supply chain 200.

With this solution, several important benefits are achieved. First, developer 220 can independently compute the digest for her source code file code.java (i.e., h(code.java)) and search the result log entries of immutable data service 224 using this independently computed digest (rather than using job ID build1234) in order to verify that her request was correctly processed. As long as adversary 250 cannot also intercept and modify the result log entries written by compiler 204, developer 220 will only find a result log entry that matches h(code.java) if compiler 204 received and compiled the correct code.java file per the design of input data auditor 300. Thus, the developer can be sure that the binary identified in a matched result log entry maps to her original source code and not some tampered version.

Second, in any scenario where an adversary surreptitiously tampers with the input data for a given transformer of software supply chain 200, the result log entry generated by that transformer and logged in immutable data service 224 will necessarily be “orphaned,” which means that it will include an input digest that does not link to the output digest of any other result log entry or to the digest of any input data held in SCM system 202. This is because the transformer will compute the input digest based on the tampered data that it receives/sees, which does not correspond to the output of any other transformer in the supply chain (or to data in a known data source). As a result, auditors and other parties can scan immutable data service 224 in order to identify these orphaned entries and thereby detect data tampering.

The remaining sections of this disclosure provide additional details regarding the implementation of input data auditor 300, including the use of secure hardware enclaves to secure the operation of this component and its communication with immutable data service 224 from adversarial attacks/tampering. It should be appreciated that FIGS. 1, 2A-2C, and 3 are illustrative and not intended to limit embodiments of the present disclosure. For example, although data processing pipeline 100 of FIG. 1 comprises a single, sequential chain of transformers 102(1)-(N), in practice more complex chains are possible (e.g., the output of one transformer may feed into multiple downstream transformers, certain transformers may run in parallel, etc.). The techniques of the present disclosure are applicable to all such data processing pipelines, regardless of the degree of complexity of their transformer chains.

Further, although FIGS. 2A-2C illustrate the specific problem of a man-in-the-middle attack on a software supply chain 200 and the need to secure the supply chain against such attacks, it should be noted that the same types of attacks may be perpetrated on software supply chain reporting tools/pipelines, rather than (or in addition to) the software supply chains themselves. Accordingly, the techniques proposed herein may also be applied to securing those reporting tools/pipelines in order to prevent false/erroneous security reports regarding the supply chains from being created and disseminated.

### 4. Transformer Workflow

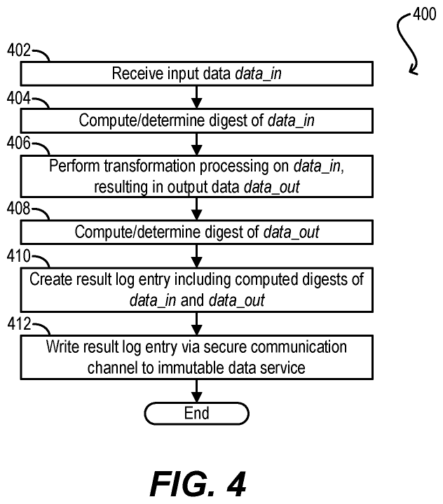

FIG. 4 depicts a workflow 400 that can be performed by a transformer of a data processing pipeline for processing input data data_in received by the transformer and, as part of this processing, computing and logging a digest of data_in in accordance with input data auditor 300 of FIG. 3.

Starting with steps 402 and 404, the transformer can receive input data data_in from an upstream transformer in the data processing pipeline or from a known data source (such as data source 104 of FIG. 1) and can compute/determine a digest of data_in. As mentioned previously, this digest (referred as the “input digest”) may be a cryptographic hash or multi-hash that is generated by applying a cryptographic hash function (e.g., SHA-256) to the data content of input data data_in. Alternatively, the input digest may be a content identifier (CID) that assigned to data_in based on its content by, e.g., a content-addressable file system such as the Inter Planetary File System (IPFS).

At step 406, the transformer can perform its designated transformation processing on data_in, resulting in output data data_out. For example, if the transformer is a compiler and the input data is a source code file, the compiler can compile the source code file into a binary file. The transformer can then compute/determine a digest of data_out (referred to as the “output digest”) (step 408) and generate a result log entry that includes the input digest computed at step 404 and the output digest computed at step 408 (step 410). In various embodiments, the result log entry can also include other information regarding the processing it has performed on data_in, such as a job ID, a digest of the transformer itself, and a digest of any runtime parameters applied as part of the processing.

Finally, at step 412, the transformer can write, via a secure communication channel, the result log entry to an immutable data service such as service 224 of FIG. 3 and the workflow can end.

### 5. Tampering Detection Workflow

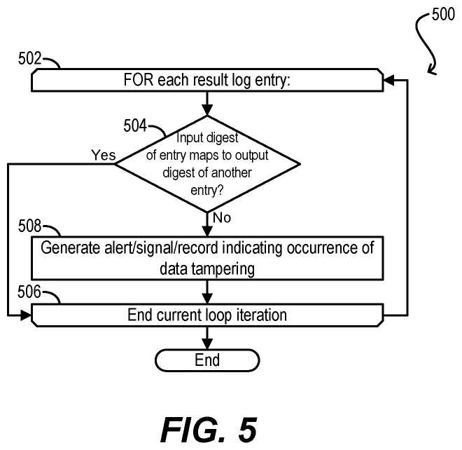

FIG. 5 depicts a workflow 500 that may be performed by an auditor or other party for detecting tampering in a data processing pipeline according to certain embodiments. Workflow 500 assumes that each transformer in the data processing pipeline has created result log entries in an immutable data service that record input and output digests per workflow 400 of FIG. 4.

Starting with step 502, the auditor can enter a loop for each result log entry present in the immutable data service. Within this loop, the auditor can check whether the input digest identified in the result log entry maps to an output digest of another result log entry, or to the digest of a data instance in a known data source for the pipeline (step 504). If the answer yes, the auditor can immediately proceed to the end of the loop iteration (step 506) and return to the top of the loop as needed to process the next result log entry.

However, if the answer at step 504 is no, the auditor can conclude that the current result log entry is an orphaned entry and thus indicates data tampering. As a result, the auditor can generate an alert, signal, or other record that identifies the output data specified in the result log entry as being tainted/tampered (step 508) before proceeding to the end of the loop iteration. Once all of the result log entries in the immutable data service have been processed, the workflow can end.

### 6. Leveraging Secure Hardware Enclaves

In order for the techniques of the present disclosure to work as intended, it is important that the input data auditor logic implemented by a transformer cannot be subverted by an adversary. In other words, an adversary should not be able to modify the transformer to create an incorrect input digest or to change the result log entry that is written by the transformer to the immutable data service.

One way to ensure this is to verify and run the code of input data auditor 300 within a secure hardware enclave. As known in the art, a secure hardware enclave (also called a hardware-assisted trusted computing environment or TEE) is a region of computer system memory, allocated via special set of central processing unit (CPU) instruction codes, where user-world code can run in a manner that is isolated from other processes running in other memory regions (including those running at higher privilege levels). Examples of existing technologies that facilitate the creation and use of secure hardware enclaves include SGX (Software Guard Extensions) for x86-based CPUs and TrustZone for ARM-based CPUs.

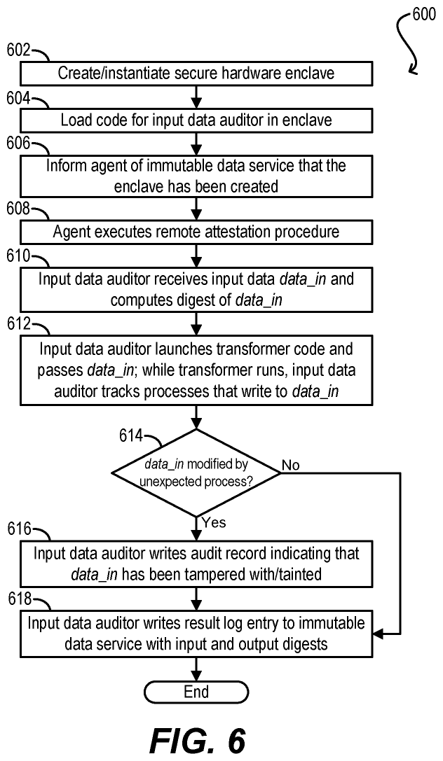

FIG. 6 depicts a workflow 600 for leveraging a secure hardware enclave to implement transformer workflow 400 of FIG. 4 in a secure manner according to certain embodiments. Starting with steps 602 and 604, the transformer can create/instantiate a secure hardware enclave on the machine hosting the transformer and load program code for input data auditor 300 into the enclave. The particular method used to perform steps 602 and 604 will be different depending on the type of the enclave (e.g., SGX, TrustZone, etc.), but in general this process entails invoking one or more special CPU instruction codes that are provided by the CPU architecture of the machine to enable enclave creation. The result of these steps is the allocation of a protected region of system memory that corresponds to the secure hardware enclave and the loading of input data auditor 300 into this protected memory region.

At steps 606 and 608, the transformer can inform an agent of immutable data service 224 that the secure hardware enclave has been created and, in response, the agent can execute a remote attestation procedure with respect to the enclave. This remote attestation procedure enables the agent to verify that (1) the enclave is a “true” secure hardware enclave (i.e., an enclave created via the special CPU instruction codes mentioned earlier), and (2) the correct program code for input data auditor 300 has indeed been loaded into, and is actually running within, the created secure hardware enclave. Thus, with step 608, agent can rule out the possibility that an attacker running malicious code is attempting to masquerade as the transformer/input data auditor 300.

Like enclave creation/load, the particular method for performing remote attestation will vary depending on enclave type/CPU architecture and thus is not detailed here. For example, Intel provides one method of remote attestation that is specific to SGX enclaves on x86-based CPUs. One detail worth noting is that, as part of the remote attestation procedure, a secure communication channel (e.g., Transport Layer Security (TLS) session) will be established between immutable data service 224 and input data auditor 300 and this secure channel will be used for all subsequent communication between these two entities.

Upon successful completion of the remote attestation procedure, input data auditor 300 (running within the secure enclave) can receive input data data_in and compute/determine a digest of input_in based on its content (step 610). Input data auditor 300 can then launch the transformer code that is designated to process the input data (which may reside outside of the secure hardware enclave) and pass data_in to that code (step 612). While the transformer code is running, input data auditor 300 can track the processes that perform writes to the input data.

Once the transformer code has completed its operation and has exited, input data auditor 300 can check to see if data_in was modified by an unexpected process (e.g., a process other than the invoked transformer code) (step 614). If so, input data auditor 300 can write an audit record to immutable data service 224 indicating that data_in has been tampered with/tainted (step 616).

Finally, at step 618, input data auditor 300 can write a result log entry to immutable data service 224 can includes the input digest computed at step 610, a digest of the resulting transformer output, and other relevant information and the workflow can end.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system implementing a transformer in a data processing pipeline, input data for the transformer;
computing, by the computer system, an input digest based on the input data;
processing, by the computer system, the input data via the transformer, the processing resulting in output data;
computing, by the computer system, an output digest based on the output data; and
writing, by the computer system, a log entry including the input digest and the output digest to a storage location.

2. The method of claim 1 wherein the input digest is a cryptographic hash, multi-hash, or content identifier of the input data.

3. The method of claim 1 wherein the log entry is immutable upon being written.

4. The method of claim 1 wherein the log entry is communicated to the storage location via a secure communication channel.

5. The method of claim 1 further comprising:
scanning the storage location to identify orphaned log entries with input digests that do not map to an output digest of any other log entry; and
upon detecting such an orphaned log entry, generating a signal or record indicating an occurrence of data tampering in the data processing pipeline.

6. The method of claim 1 wherein the computing of the input digest and the writing of the log entry are performed by program code running within a secure hardware enclave of the computer system.

7. The method of claim 1 wherein the data processing pipeline is a software supply chain and wherein the transformer is a data transformation or processing step within the software supply chain.

8. A non-transitory computer readable storage medium having stored thereon program code executable by a computer system implementing a transformer in a data processing pipeline, the program code embodying a method comprising:
receiving input data for the transformer;
computing an input digest based on the input data;
processing the input data via the transformer, the processing resulting in output data;
computing an output digest based on the output data; and
writing a log entry including the input digest and the output digest to a storage location.

9. The non-transitory computer readable storage medium of claim 8 wherein the input digest is a cryptographic hash, multi-hash, or content identifier of the input data.

10. The non-transitory computer readable storage medium of claim 8 wherein the log entry is immutable upon being written.

11. The non-transitory computer readable storage medium of claim 8 wherein the log entry is communicated to the storage location via a secure communication channel.

12. The non-transitory computer readable storage medium of claim 8 wherein the method further comprises:
scanning the storage location to identify orphaned log entries with input digests that do not map to an output digest of any other log entry; and
upon detecting such an orphaned log entry, generating a signal or record indicating an occurrence of data tampering in the data processing pipeline.

13. The non-transitory computer readable storage medium of claim 8 wherein the computing of the input digest and the writing of the log entry are performed by program code running within a secure hardware enclave of the computer system.

14. The non-transitory computer readable storage medium of claim 8 wherein the data processing pipeline is a software supply chain and wherein the transformer is a data transformation or processing step within the software supply chain.

15. A computer system implementing a transformer in a data processing pipeline, the computer system comprising:
a processor; and
a non-transitory computer readable medium having stored thereon program code that, when executed, causes the processor to:
receive input data for the transformer;
compute an input digest based on the input data;
process the input data via the transformer, the processing resulting in output data;
compute an output digest based on the output data; and
write a log entry including the input digest and the output digest to a storage location.

16. The computer system of claim 15 wherein the input digest is a cryptographic hash, multi-hash, or content identifier of the input data.

17. The computer system of claim 15 wherein the log entry is immutable upon being written.

18. The computer system of claim 15 wherein the log entry is communicated to the storage location via a secure communication channel.

19. The computer system of claim 15 wherein the program code further causes the processor to:
scan the storage location to identify orphaned log entries with input digests that do not map to an output digest of any other log entry; and
upon detecting such an orphaned log entry, generate a signal or record indicating an occurrence of data tampering in the data processing pipeline.

20. The computer system of claim 15 wherein the program code that causes the processor to compute the input digest and write the log entry runs running within a secure hardware enclave of the computer system.

21. The computer system of claim 15 wherein the data processing pipeline is a software supply chain and wherein the transformer is a data transformation or processing step within the software supply chain.
